(19) United States
(12) Patent Application Publication
(10) Pub. No.: US 2012/0215553 A1
(43) Pub. Date: Aug. 23, 2012

(54) METHOD AND SYSTEM OF VALIDATING AND VERIFYING HEALTH CARE TRANSACTIONS

(76) Inventor: Jeff LESTON, Edwardsville, IL (US)

(21) Appl. No.: 13/368,938

(22) Filed: Feb. 8, 2012

Related U.S. Application Data
(60) Provisional application No. 61/440,845, filed on Feb. 8, 2011.

(51) Int. Cl. G06Q 50/22; G06Q 40/08

(52) U.S. Cl. 705/2

(57) ABSTRACT

The disclosed embodiments relate generally to a method and system identifying health care providers who are authorized to submit health care claims to health insurer or claims processor. Also provided is a system and method verifying that providers who submit claims are operated in location(s) attested and that those location(s) are legitimate sites for delivery of healthcare services. Utilized are novel algorithms to compare information from provider's credit card terminal to information commonly held by insurance company and identify beneficiaries and dependents who are eligible to receive services capturing health care encounter at point of service, and capturing location and time of health care encounter of authorized beneficiary or dependent at the authorized location of a provider. Further is a process and system to verify healthcare transaction seeking payment, submitted by the provider, which is matched against information created, and used to verify certain healthcare transactions for approval and/or payment.

### FIELD OF THE INVENTION

The present invention generally relates to a method and system of verifying health care claims made for payment, particularly to such a method and system wherein electronic health care encounter information is communicated from a transmitting device or machine to a data base.

### BACKGROUND OF THE INVENTION

According to the US Government General Accounting Office, approximately 10% of health care claims are fraudulent or abusive. This costs the United State between $125 Billion and $175 Billion annually. In a typical scenario, a provider (physician, pharmacy, medical equipment supplier, dentist, for example) submits a claim to a health insurer or their claim processor for payment of services rendered to an insured customer or member of the health plan. Because of the number of claims (billions annually) and the number of providers (millions) who are authorized to submit claims to government sponsored and private health plans, it has been impossible prior to this invention to independently verify that a recipient or beneficiary or member of a health plan was in the provider office when the claim, submitted as a separate process, stipulates.

Prior to any payment, the provider submitting the claim (physician, pharmacy, dentist, optometrist, etc) must be authorized by the health plan or paying authority to submit claims for payment. Also, the claim submitted by the provider must have the identification (health plan member number) of the health plan member. When the claim is submitted, certain information must be in order for the claim to be paid. Claims must contain the identification of the provider authorized to deliver the product or service, the name and plan identification of the health plan member or insured; the date the service was provided and description of the service provided or product delivered (such as durable medical equipment) which is indicated by a code.

In addition, the recent proliferation of web portals has made it easier to commit fraud and abuse. Since claim information sometimes only requires a legitimate provider identification and legitimate insured identification, such as a Social Security Number for Medicare recipients, researching that information on web portals has made false claims easier to file and be paid.

Health care claims, in order to be paid, contain information on 1) the provider who is submitting the claim and wishes to be paid; 2) the insured individual to whom the medical product was delivered or service rendered, 3) the date of service of the treatment or product delivery, and 4) details and codes describing the service or product rendered. Fraudulent claims can be easily submitted and paid.

Thus, there still remains in the art a need for solving the problems associated with fraud and abuse in health care services.

### SUMMARY OF THE INVENTION

The present invention provides for solving the problems associated with fraud and abuse in health care services. This invention can verify that certain aspects of the healthcare claim can be verified prior to payment. Disclosed is a system and method that creates a “risk profile”, or the likelihood that the healthcare provider is submitting fraudulent or abusive claims, based on information from their 1) credit card terminal, 2) their willingness to participate and give us information (behavioral information) 3) changes in billing data, numbers of addresses and billing numbers on file (may be legitimate, but a risk element nonetheless) and 4) comparison of these data to claims that the provider submits.

The present invention provides a method and system of identifying health care providers who are authorized to submit health care claims to a health insurer or claims processor. The system and method verifies that healthcare providers who submit claims are operate in the location[s] that they attest to and that those locations are legitimate sites for the delivery of healthcare services. Information is compared from a provider's credit card terminal to information commonly held by an insurance company. Beneficiaries and their dependents are identified who are eligible to receive health care services and a health care encounter at the point of service is captured as well as the location and time of a health care encounter of an authorized beneficiary or dependent at the authorized location of a health care provider.

The invention further provides a process and system to verify that a healthcare transaction that is seeking payment is submitted by a health care provider that can be matched against information on the encounter created by this invention. The created information is so used to verify certain healthcare transactions for approval and/or payment.

In one embodiment, the invention generally relates generally to a method of verifying health care claims made for payment, particularly to such a method wherein electronic health care encounter information is communicated from a transmitting device or machine to a data base.

The verification card system is comprised of at least one identification card issued to a health care provider having a unique number encoded on it, the number comprising a banking identification number corresponding to the verification card system, and at least one identification card issued to a health care plan member or beneficiary or recipient having a unique number encoded on it, the number comprising a banking identification number corresponding to the verification card system, means for receiving health care product or service code information from an existing point-of-sale device when the provider card and/or the recipient card is swiped through the point-of-sale device, a means for converting that code into a code of field which can be read by health care claims payment systems, a means for storing and accessing the unique card numbers of health care providers and verifying that the provider to whom that card is assigned is eligible to provide products and services to the patient or family member whose card is also swiped, and identification numbers of swipe terminals and associating them with identifications of health care providers and a means for storing and accessing unique card numbers and associating them with health care plan members and their associated beneficiaries, a means for determining which types of swipe terminals may be authorized to send information to the computer system and be considered for payment; an means for comparing the information captured from the swipe[s] of provider and health plan member cards on the point-of-sale system with a claim submitted by the authorized health care provider, and a means to identify claims submitted by unauthorized health care providers and a means to identify claims submitted by health care providers where the recipient has not swiped a card in the office of the provider submitting the claim.

In another embodiment, the verification system is comprised of at least one identification card issued to a health care provider having a unique number encoded on it, the number comprising a banking identification number corresponding to the verification card system, and at least one identification card issued to a health care plan member or beneficiary or recipient having a unique number encoded on it, the number comprising a banking identification number corresponding to the verification card system, means for receiving health care product or service code information from an existing point-of-sale device when the provider card and/or the recipient card is swiped through the point-of-sale device, a means for converting that code into a code of field which can be read by health care claims payment systems, a means for storing and accessing the unique card numbers of health care providers and verifying that the provider to whom that card is assigned is eligible to provide products and services to the patient or family member whose card is also swiped, and identification numbers of swipe terminals and associating them with identifications of health care providers and a means for storing and accessing unique card numbers and associating them with health care plan members and their associated beneficiaries, a means for determining which types of swipe terminals may be authorized to send information to the computer system and be considered for payment; an means for comparing the information captured from the swipe[s] of provider and health plan member cards on the point-of-sale system with a claim submitted by the authorized health care provider, and a means to identify claims submitted by unauthorized health care providers and a means to identify claims submitted by health care provider's where the recipient has not swiped a card in the office of the provider submitting the claim.

Depending on the implementation, the verification card system of the present invention may also comprise at least one magnetic stripe card associated with a patient or health plan member, a database relating the number of that card to the health plan identification number, and computer code to create from the card information and keystrokes on the point of sale device a query to the health plan computer system regarding information that health plan has on its system regarding that individual or their family, and a software-controlled system to allow or deny that swipe terminal to receive such information. The invention further comprises a method to allow the information to be displayed on a web browser of a provider authorized by the health plan to see such information. The invention also comprises a method to submit a health care claim from the information stored on the provider card, the provider swipe terminal, the health plan member card and a code entered into the point-of-sale system. The invention also comprises a method to store a code identifying the health plan that the card holder is covered by, and a method to update such information.

The verification system may further comprise a computer system at least one identification card that office There is no verification that the service was ever rendered or that the insured was actually in the office or store of the provider claiming for payment. Insured are sometimes sent a benefits statement that lists claims made on their behalf, but increasingly these are electronic, made optional, and if they do not require payment by the insured, are ignored.

The foregoing objects are achieved and other features and advantages of the present invention will become more apparent in light of the following detailed description of exemplary embodiments thereof, as illustrated in the accompanying drawings.

### BRIEF DESCRIPTION OF THE DRAWINGS

In the drawings, wherein similar reference characters denote similar elements throughout the several views:

FIG. 1 shows a diagram of one embodiment of issuance of a provider card.

FIG. 2 shows a diagram illustrating an embodiment of issuance of a health plan member card.

FIG. 3A illustrates one embodiment of a matching process.

FIG. 3B shows another illustration of a matching process.

FIG. 4A is a block diagram illustrating card networks.

FIG. 4B shows a block diagram illustrating a provider card terminal registration process.

FIG. 4C illustrates a block diagram showing one embodiment of portal access using a patient card.

FIG. 5 shows a flow diagram of assignment of cards and establishment of database entries.

FIG. 6 shows a flow diagram illustrating transaction capture at point of care.

FIG. 7 shows a flow diagram illustrating data extract and matching process.

FIG. 8A shows a flow diagram illustrating one embodiment of the present invention.

FIG. 8B shows a flow diagram and is a continuation of FIG. 8B.

### DETAILED DESCRIPTION

The invention will now be described in detail with reference to the accompanying drawings. The present invention relates to a healthcare claim verification system and method which allows for the verification of location, time and services or health care products delivered. The system and method also provides for matching of claims for payment submitted by health care providers. Further, the system and method provides for the ability to access additional information about the owner of the card, and process certain health care transactions from the point-of-sale terminal, and from a web browser from a provider authorized by the health plan with this invention.

The system and method comprises a plurality of cards issued to providers and to a plurality of cards issued to health plan members, a sponsor bank processor, and a processing hub, which serves at the nerve center of the system. In order to achieve the desired functionality, the system uses the existing banking networks in a unique and novel way to gain access to virtually all existing retail point-of-sale (POS) devices, computers with POS interfacing, cash registers with POS interfacing and other similar devices which can be used to access the banking system. As used herein, POS device includes all such devices, and includes data entry which is effected both by swiping a care through the device and by manual entry. Further, the system incorporates a method to establish a relationship between a web browser and a POS terminal from an authorized health care provider.

To access these POS devices, the operator of the system and method must apply for and obtain a Bank Identification Number (BIN) from the American Banking Association. The BIN serves as a unique identifier of the verification card system within the banking network. The BIN is encoded on a magnetic strip on each card in the system as a part of the card's identification number. Alternatively or additionally, the BIN and identification number can be encoded as a bar code, or provided by any other means known in the art.

The BINs will be able to be read by the POS devices which are pre-programmed to recognize only certain types of cards, such as those from VISA®, MasterCard®, and American Express®. By using one of these numbers, the card will be recognized by almost all POS devices, and occurs regardless of the POS device used.

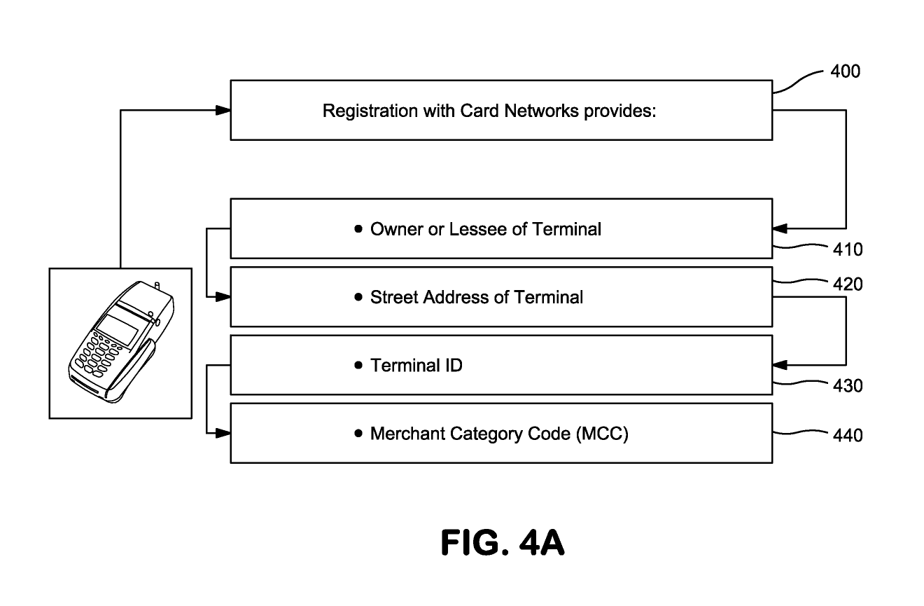

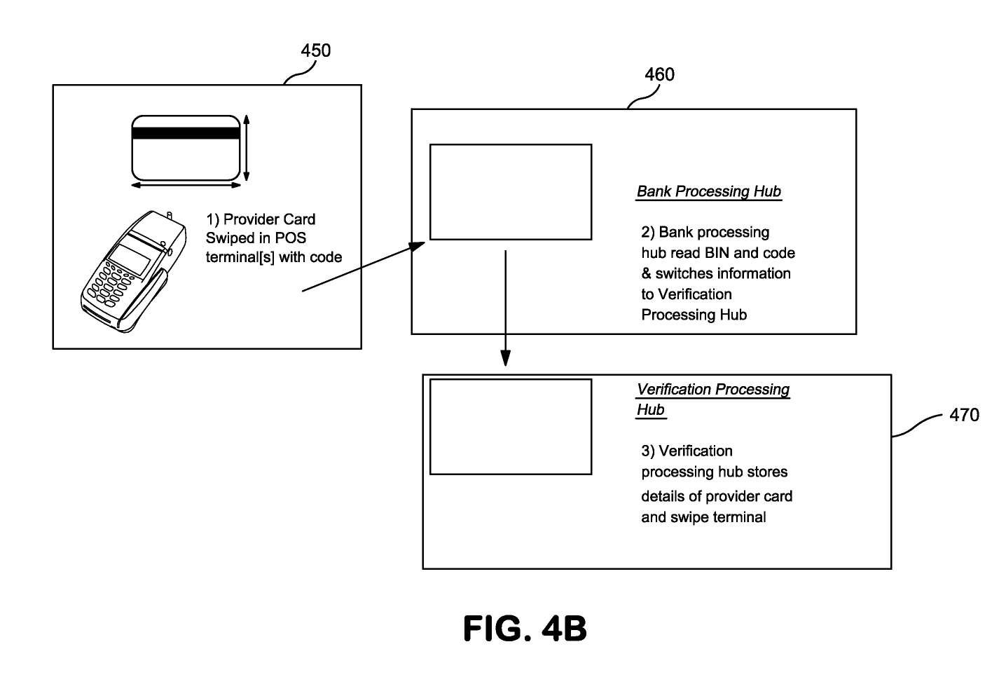

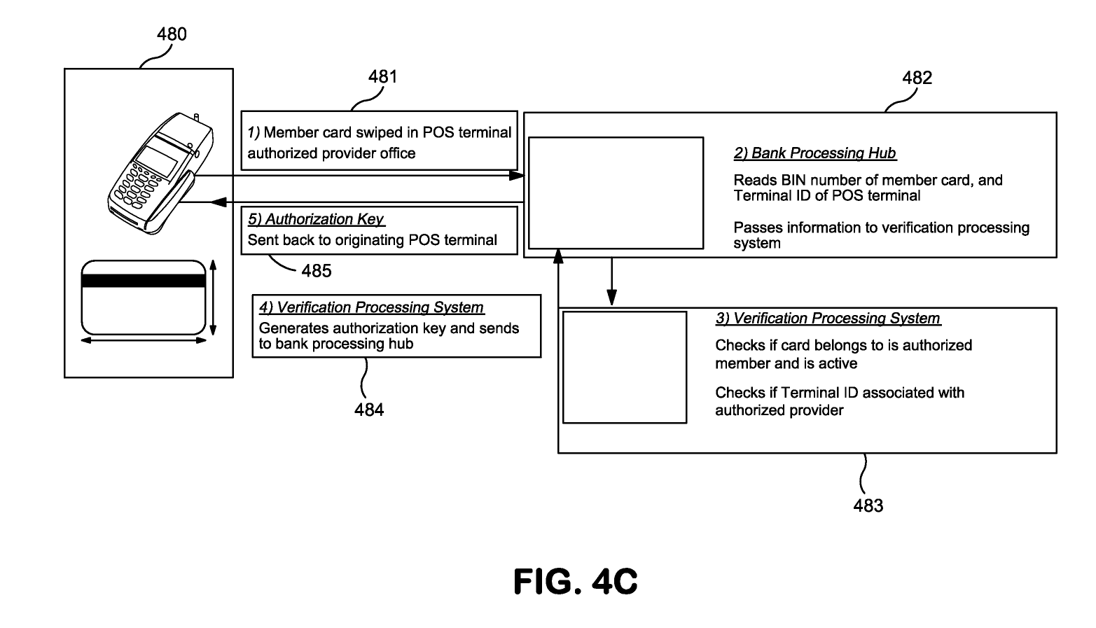

Adverting to FIG. 4A, each swipe terminal authorized to process credit and debit card transactions is installed by an independent third party and linked to their the identified in multiple ways. When a card is swiped the owner or lease personnel of the terminal is identified and available to the operator of the system along with the location of the swipe terminal.

The processing hub also comprises a code to identify that the location is a street address, a mobile or wireless terminal, a terminal operating in a vehicle such as a Para transit vehicle that has been authorized to provide services to a health plan. In addition, the Terminal ID, an alphanumeric set of characters unique to each terminal, is available to the operator of the system, as is a Merchant Category Code (MCC) which identifies the industry sector and sub sector that the owner or lease personnel of the terminal operates in.

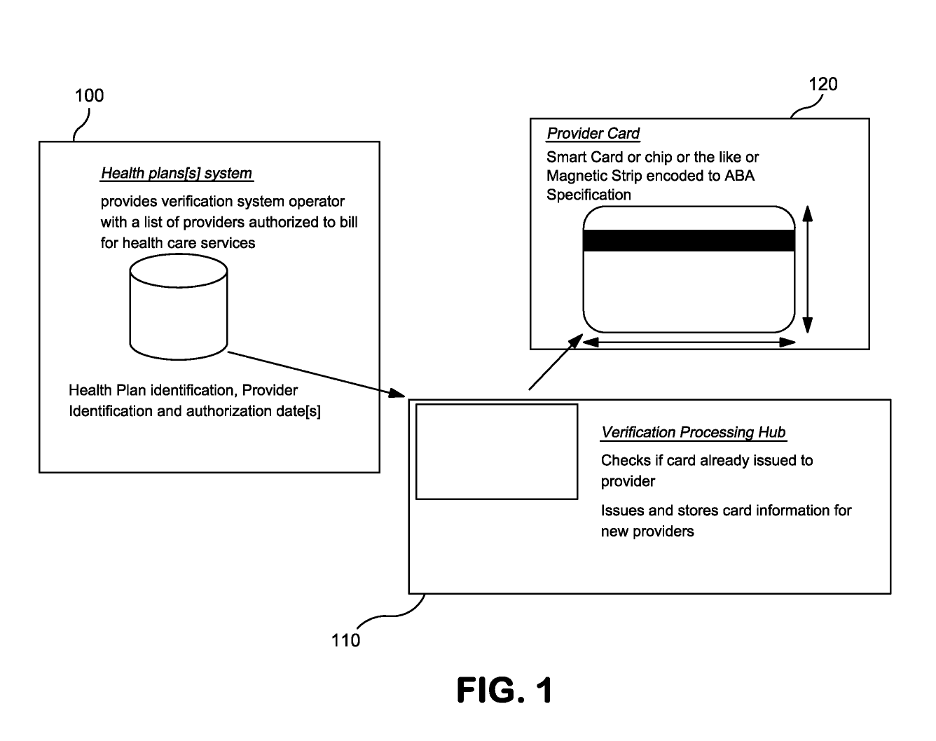

As shown in FIG. 1, issuance of provider card, a plurality of health plans may contract with the operator of the verification system to issue magnetic stripe cards or card with a chip or the like, to the providers they authorized to submit claims and the members of their health plans. The cards are not limited to magnetic cards, smart cards with chips, or any other card or non-card medium, but include any type of medium that stores data. The use of the word “card” is meant to include one or more different types of mediums holding data. The cards are pre-assigned in the processing hub to the authorized providers. The processing hub will, depending on the embodiment, also contain the UPIN (Universal Provider Identification Number) for the provider for whom a card has been issued and the identification of the health plan[s] for which that provider is eligible to submit claims. If a provider is no longer eligible to submit claims to a health plan, that health plan identification will be removed from the provider record on the verification system. Health plan(s) system 100 is in communication with Verification processing hub 110 and Provider card 120. Again, the invention is not limited to a magnetic card, but may include a smart card(chip) or any other medium containing data. Communication links are preferably data links. Such data link can alternatively be, but is not limited to, an electronic data link, optical fiber connection, wireless data connection or any other known connection used for data transfer, for example, over the internet as an email, text message or the like, including any other communication. Depending upon the implementation, communication link can operate in one or more modes of transmission. For example, such modes include radio frequency transmissions, optical transmission, microwave transmission, digital or analog transmission, or other known data transmission.

The authorized provider will swipe the card in the POS terminal[s] and enter a pre-assigned code on the POS terminal and the information will be sent to the bank processing hub. The bank processing hub, through prior arrangement will pass the information to the verification processing system, which will capture the Terminal ID[s] for the authorized provider. Since providers may have multiple offices, the processing hub will allow the card to be swiped in multiple POS terminals. If the provider is already known to the verification processing system, and a health plan transmits to the system operator that a known provider is eligible to submit claims to that health plan, a record of such eligibility will be added to the verification processing hub.

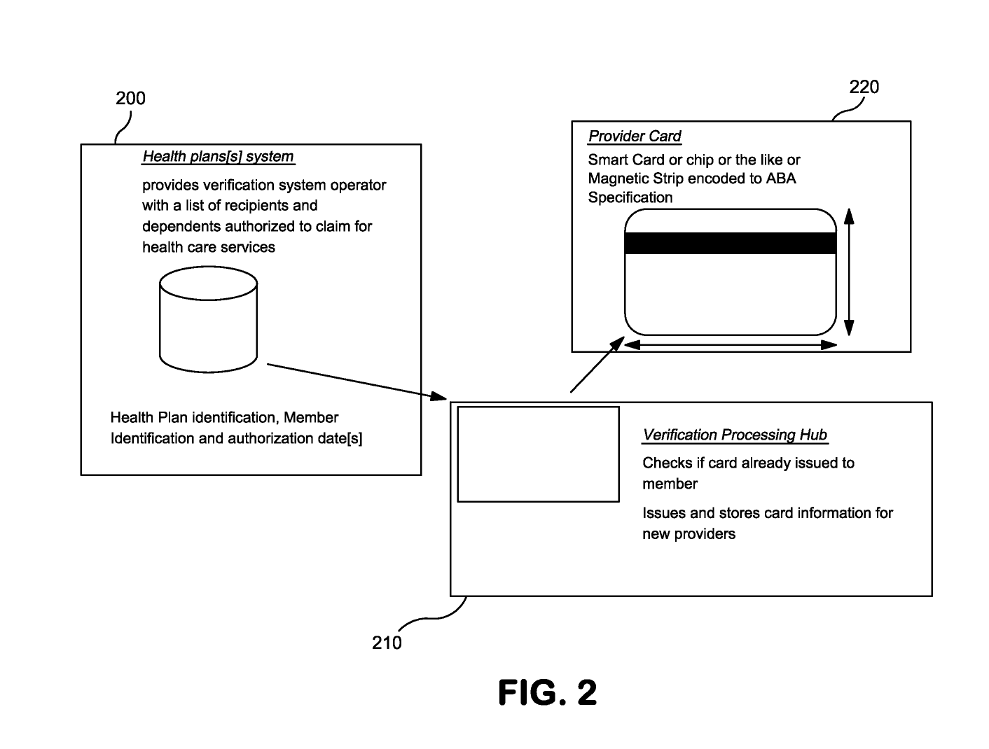

As shown in FIG. 2, issuance of a health plan member card, the health plans may also contract with the operator of the verification system to issue magnetic stripe cards or the like to the members of their health plan. The cards are pre-assigned and the processing hub will store the plan identification number with the unique BIN number. If the individual already has a card issued by the operator of the system, the operator can change, via software, the health plan which the card holder is receiving benefits from. There will be a one to one relationship between the health plan identification number and the BIN number of the card; although the plan identification number may represent that multiple individuals can receive health benefits. If the person assigned the card is no longer eligible to receive health care services from the health plan, it will be deactivated or the information about the health plan and plan identification number will be removed. Health plan(s) system 200 is in communication with verification processing hub 210 and member card 220. Member card 220 is similar in description to member card 120.

When the card holder visits a health care provider, they swipe their card in the POS terminal at the provider location. The health care provider's POS system is connected to the financial network and the swipe information is routed to the processor of the bank issuing the BIN number of the card. Through an arrangement with the processor, the information is passed to the verification processing system. A pre-assigned code is entered into the POS terminal to instruct the verification processing system what to do with the information collected from the card swipe.

In one embodiment, the processing hub is instructed to format a query to the health plan associated with the card to verify that medical products or services billed to the health plan in the name of the card owner or other individuals covered under the same plan identification of the card owner are eligible for reimbursement by the health plan. The verification processing system and method stores the Terminal ID of the originating POS terminal; said Terminal ID is transmitted as a usual and customary part of the swipe information delivered by the financial networks. The verification processing system further stores the time stamp of the swipe, which is also a usual and customary part of the swipe information delivered by the financial networks.

The verification processing system maintains a record of each swipe including the unique card number, Terminal ID and time of the swipe. Since the verification processing system contains tables that relate the Terminal ID of the originating POS terminal to providers authorized to submit claims to the health plan; and the verification processing system stores the plan identification affiliated with the member card that was swiped, as well as the names of individuals covered under that same plan identification, the verification processing system also stores the name and UPIN for the provider associated with the Terminal ID and the name of the individual present to receive medical services or products.

The verification processing system and method can also store the code for medical products or services rendered. The code for medical products or services rendered can represent a single product or procedure code, or can represent a set of products or procedure codes normally associated with each other.

One embodiment of this system and method is a dental exam, which consists of three Common Dental Terminology (CDT) codes. When 1) a pre-defined code is entered with a card swipe of a health plan member card, and 2) the MCC of the terminal is that of a dental office and identified as such by the verification system; 3) the processing hub will complete an 837D claim form filling in the 3 CDT codes for a (routine) dental examination. All health plans operate a computer system for processing claims submitted by insured members and by authorized health care providers. The standard claim form, the HCFA 1500, as well as others, require that the claim contain the name and plan identification of the insured; the name and UPIN of the provider claiming payment for the'product or service, the description of the product or service represented by a code for medical procedures (CPT or Common Procedural Terminology); for dental procedures (CDT or Common Dental Terminology); prescription drugs (NDC or National Drug Code); Durable Medical Equipment; and the date of service. These claims are either submitted to the health plan electronically in defined formats, or data entered into defined formats if submitted by paper. The health plan computer system processes the claim to determine whether it is eligible to be paid based on the specific coverage and payment or claim history of the individual.

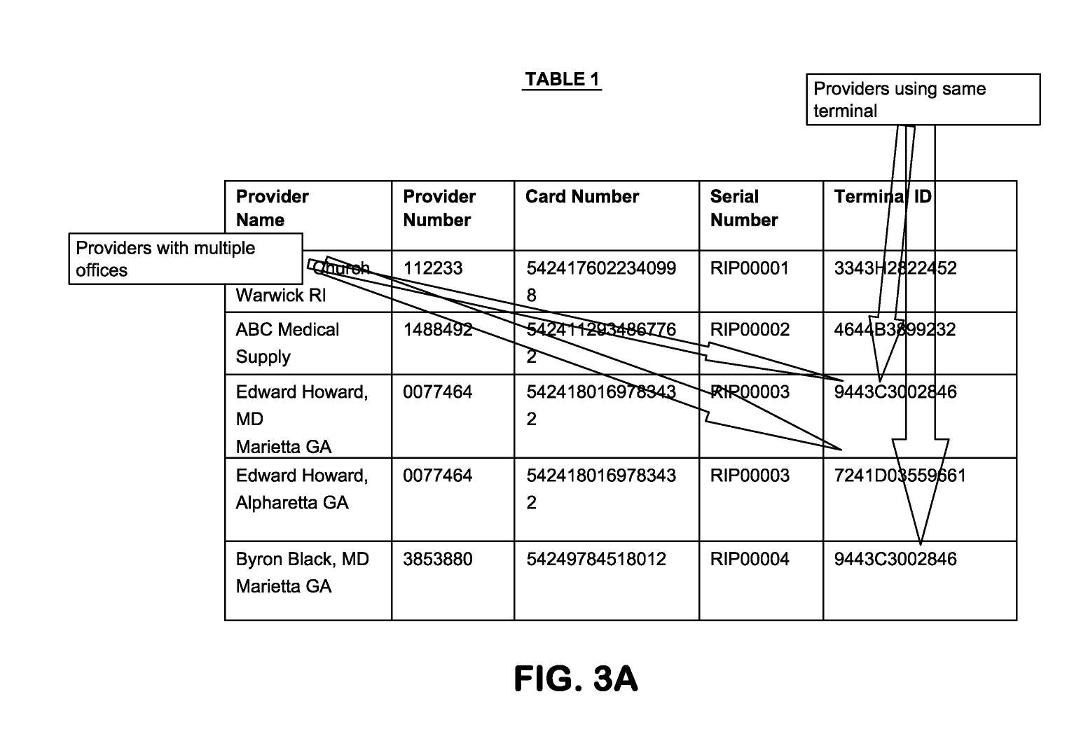

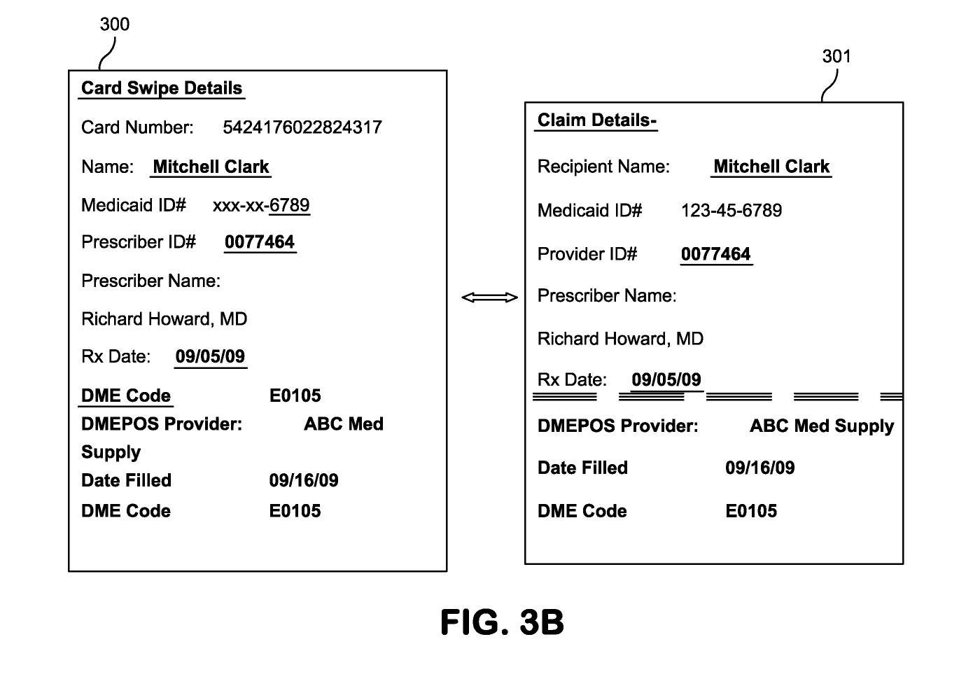

As shown in FIGS. 3A-3B, in the preferred embodiment of the system, the operator of the verification system, which may be the health plan itself, will compare the information stored at the processing hub, namely provider name, patient name, product or service code, and date of service- to those fields from the corresponding claim. If there is not a record of the processing hub having such information, the health plan can deny or suspend payment pending further investigation. FIG. 3A shows Table 1 having provider names and related numbers and terminal identification. FIG. 3B shows a matching process between information in blocks 300 and 310. The information is given as an example only within these blocks and is no means meant to limit the information contained within the blocks.

In one embodiment of the system and method, the information from the swipe, patient name, product or service code, will be matched at a third location such as a pharmacy or medical supply house to verify that a legitimate prescription or certificate of medical necessity has been originated at a physician office prior to payment. Depending on the embodiment, the card number will be taken directly from the swipe information transmitted to the bank processing hub, and passed to the verification system after reading the BIN number. The verification system, having stored the health plan member and dependents names based on the process shown in FIG. 2, will create a record of that for the matching process. The Terminal ID of the swipe will be related to provider identification, which has been stored as a result of the process demonstrated in FIG. 1.

Shown in FIGS. 4A-4B-4C, when the health plan has provided a web (Internet) portal to its authorized providers, the providers may want to use the portal for one of a number of transactions; to see the information that the health plan has regarding the coverage of a health plan member, and/or to submit a claim on behalf of that plan member. When the member card is swiped in the provider office, a return code will be sent to the POS terminal, at the same time the processing hub will create a query to the web portal requesting information about the member whose card was swiped. The operator of the system will provide a web site into which the return code will be entered. The web site will store login instructions for the provider portal for the health plan designated in the member record illustrated in FIG. 2, and will sign the provider's browser onto the appropriate web site for the plan for which that member belongs. When the code is entered, the processing hub will format a web services query to the appropriate health plan web site and the results will be displayed on the web browser which entered the code. For purposes of this invention, “health plan” means any insurance, discount plan, specialty insurance for vision care, dental care, or similar specialty, whether offered by a private insurer or governmental entity. As shown in FIG. 4A, block 400 registration with card networks provides owner or lessee of terminal 410, street address of terminal 420, terminal identification 430, and merchant category code (MCC) 440. FIG. 4B, provider card terminal registration process, shows block 450 provider card in communication with block 460 bank processing hub and block 470 verification processing hub. FIG. 4C illustrates a portal access using patient card. Block 480 represents a card and terminal. Block 481 represents a member's card swiped at a POS terminal. Block 482 represents a bank processing hub. Block 483 represents a verification processing system. Block 484 represents a verification processing system and block 485 represents authorization key sent back to original POS terminal. All blocks are in communication with each other as previously described.

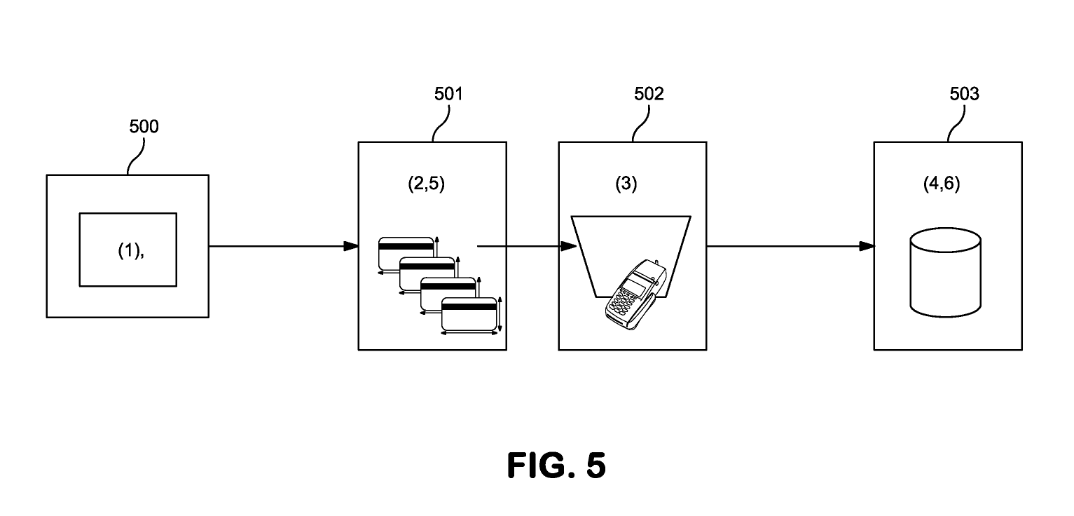

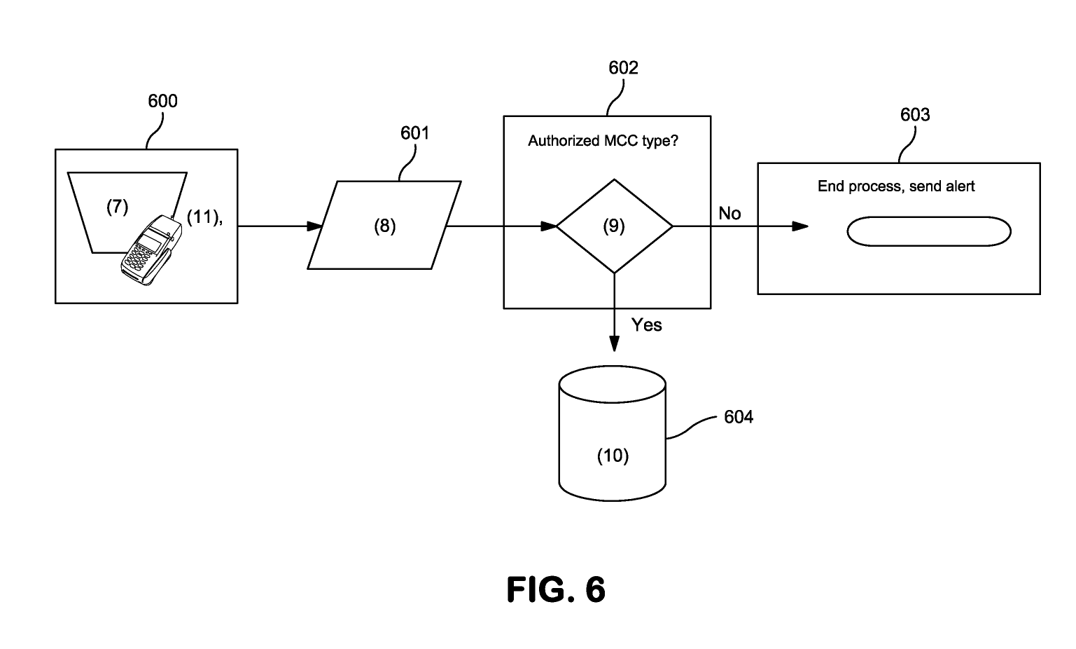

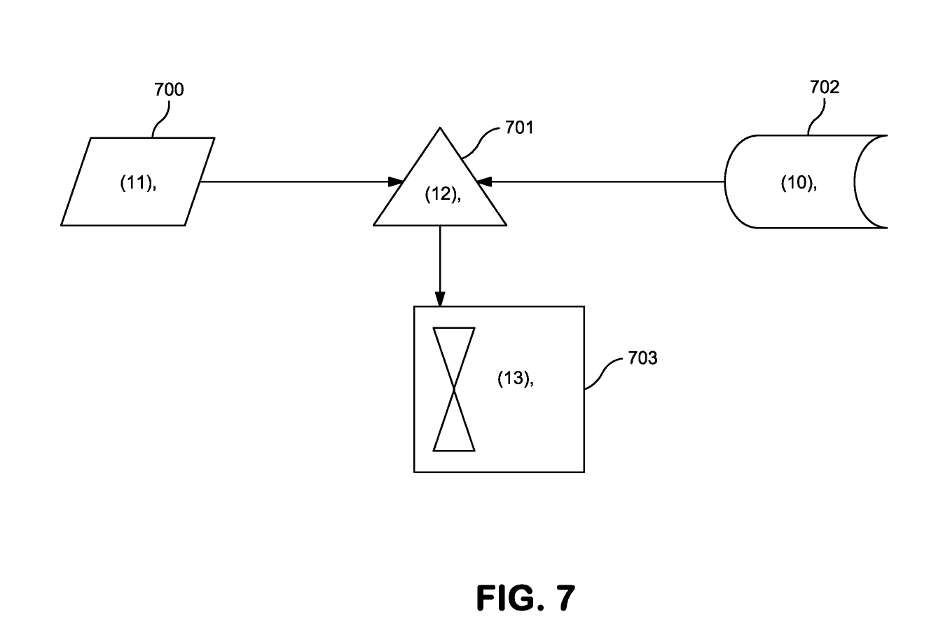

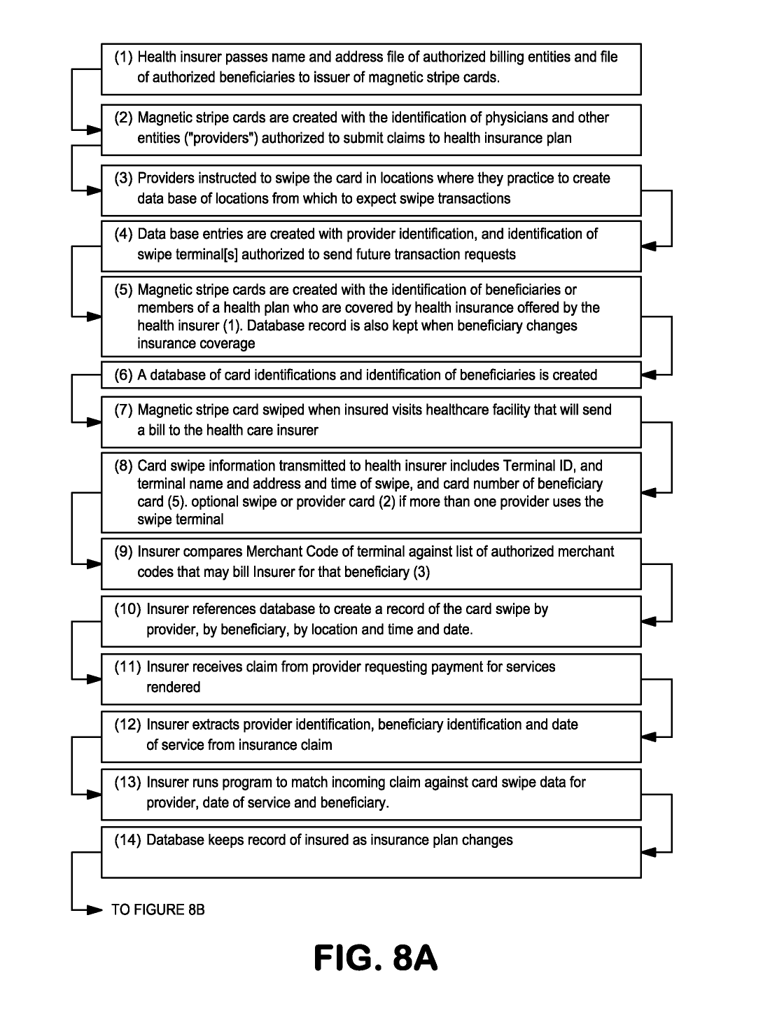

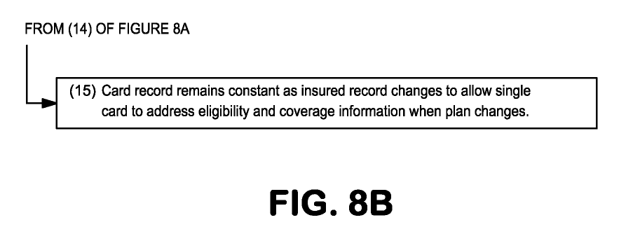

Illustrated in FIG. 5 through FIG. 7 are block diagrams relating to the process outlined in FIGS. 8A-8B; Processing Hub Technical Details. The numbers illustrated in FIGS. 5 through 7 related to the numbers shown in FIGS. 8A-8B. The steps shown in 8A-8B may be accomplished in any sequence. In FIG. 5, shown is an assignment of cards and establishment of database entries. Block 500 contains the process steps of step 1 in FIGS. 8A-8B. Block 501 contains the process steps of steps 2, and 5 in FIGS. 8A-8B. Block 502 contains the process steps of step 3 in FIGS. 8A-8B. Block 503 contains the process steps of steps 4 and 6 in FIGS. 8A-8B. Blocks 500, 501, 502, and 503 are in communication with each other as previously described. The processing hub of the present invention provides front-end POS device management and message processing for card authorization. The processing hub can be implemented using and computer and acceptable storage and processing capacity. The processing hub will have communications with a processor which communicates directly with the financial networks and devices. FIG. 6 illustrates a transaction capture at the point of care. Block 600 contains the process steps of steps 7 and 11 in FIGS. 8A-8B. Block 601 contains the process steps of step 8 in FIGS. 8A-8B. Block 602 contains the process steps of step 9 in FIGS. 8A-8B. Block 603 contains the end of process steps if the answer to block 602 is NO. If block 602 is YES, then block 604 presides. Block 604 contains the process step of step 10 in FIGS. 8A-8B. Blocks 600 through 604 are in communication with each other. FIG. 7 illustrates a data extract and matching process. Block 700 contains the process steps of step 11 in FIGS. 8A-8B. Block 701 contains the process steps of step 12 in FIGS. 8A-8B. Block 702 contains the process steps of step 10 in FIGS. 8A-8B. Block 703 contains the process steps of step 13 in FIGS. 8A-8B. Blocks 700 through 703 are in communication with each other. Depending on the implementation, blocks 700 and 702 are fed into block 701. FIG. 8A-8B illustrate one embodiment of a process using the invention. While the verification system herein described constitutes the preferred embodiment of the present invention, it is to be understood that the invention is not limited to this precise form of system and the changes may be made therein without departing from the scope of the inventions which is defined in the claims.

In one embodiment at least one card issued to a provider authorized by a health plan to claim payment for products or services, having a magnetic stripe, memory chip card (SmartCard) or the like, and having a unique identification number approved by the American Banking Association for use in a banking network, said identification number corresponding to the Universal Provider Identification Number of the provider. The at least one issued card is given to an individual to identify them as a member of a health plan to claim payment for products or services, the card having a magnetic stripe, memory chip or the like and having a unique identification number approved by the American Banking Association for use in a banking network, has an identification number corresponding to the current Identification Number of the individual other covered by the same Identification Number given by a health plan. A verification hub also contains a method to determine the health plan that the member belongs to.

In one embodiment, a bank processing hub computer under bank hub software control and in communication of a credit and debit card network with a pre-existing standard retail point of sale devices has the bank processing hub computer receiving provider, member, Terminal ID and time stamp information when said individual card is swiped, with the bank processing system recognizing the BIN number of the provider card and individual card and communicating the details of the swipe transaction to the verification processing hub.

Depending on the implementation, a verification processing system that the Bank processing hub communicates the swipe details to, and stores the swipe details has a process as follows. The verification processing system stores the identification of health plans that the provider is eligible to submit claims for payment of services rendered. Further the verification hub also stores the tables that relate the unique card number to the health plan[s] and the health plan identification number; the verification processing system stores the unique card number related to the Terminal ID, MCC (Merchant Category Code) and UPIN of the provider, stores the health plan and health plan identification associated with the unique card, stores any other information necessary to submit health care transactions. Further, the verification hub contains logic to perform certain actions based on the combination of any or all of the data elements stored and data elements transmitted from a card swipe, including codes sent from the POS terminal.

The verification processing system contains a novel method to compare the information generated from the card swipes, specifically the identification of the provider, the identification of the individual receiving services, the billing unit, as express in common industry terminology such as procedures (CPT or Common Procedural Terminology); for dental procedures (CDT or Common Dental Terminology); prescription drugs (NDC or National Drug Code); Durable Medical Equipment; and the date of service; with the same information on a claim received for payment by a health plan.

Other alternative embodiments or implementations according to the various teachings of the present invention will be understood by those skilled in the art and are achieved without departing from the spirit and scope of the invention. It is therefore intended that the present invention is not limited to the disclosed embodiments described herein.

What is claimed is:

1. A system for validating and verifying health care transactions, comprising:
a memory device; and
a processor disposed in communication with the memory device, the processor configured to:
capture the name of a provider of health care services including products;
verify that the provider and a location of the provider is authorized to provide the health care services to an individual insured by a health plan; and
allow access to information on the individual insured by the health plan if the provider is authorized by the health plan to provide the health care services.

2. The system of claim 1, wherein the processor is further configured to:
verify that the individual has physically visited a location authorized by the health insurance plan to receive health care products or services under that plan.

3. A system for validating and verifying health care transactions, comprising:
a memory device; and
a processor disposed in communication with the memory device, the processor configured to:
capture time and location and details of a visit by a person to an authorized health care provider location;
deliver information to a health care insurer or claim processor in real time; and
provide a process of matching health care encounter information captured at the location of the health care provider with claim information submitted to a health insurance company or claim processor as a separate process from the medical visit.

4. The system of claim 3, wherein the processor is further configured to:
identify attempts to submit claims from locations that are not authorized by a health plan to submit health care claims for payment by said health insurer.

5. The system of claim 3, wherein the processor is further configured to:
identify claims where the provider has not delivered a specified product or service to an insured.

6. The system of claim 3, wherein the system further includes:
at least one magnetic strip card or smart card with a chip issued to patients;
at least one card issued to health care providers;
a means of communicating information from provider offices and the system;
a means of communicating information from other locations where health care services may be delivered.

7. The system of claim 3, wherein the processor is further configured to:
communicate healthcare transactions initiated through point of sale terminals and match those transactions for payment.

8. The system of claim 3, wherein the processor is further configured to:
receive authorized provider information from a health care insurance company or company who provides claim processing services to a health insurer; and
create a card for an authorized provider of health care services.

9. The system of claim 8, wherein the processor is further configured to:
register with a computer system at least one magnetic stripe terminal used for the processing credit and debit cards and compare the terminal to the one used to capture a patient encounter.

10. The system of claim 3, wherein the processor is further configured to:
compare the information from the swipe to information provided by the credit card networks to verify that the location is a valid type of merchant authorized to submit claims to a health plan for payment;
notify health plans of attempts to verify patient visits from locations that have not been registered with the health plan and further notify the health plan of attempts to capture patient visits from location types not authorized by the health plan.

11. The system of claim 3, further including:
a card given to an individual or family member by a health insurance plan, wherein when the card is swiped at an office authorized by an insurance company the information from the swiped card is sent to a processing hub, and the information compared to other information provided by the health plan or insurer as to the eligibility of the member to receive medical services and the eligibility of the provider location to provide medical products or services.

12. The system of claim 11, wherein information generated by the swiped card of the health plan member's card which are the Terminal ID of the card swipe terminal, the name of the owner of the terminal, the Merchant Code (MCC) of the terminal and the time of the swipe of a card and code entry into a display unit are transmitted to a computer system and compared to information sent by a health care provider seeking payment.

13. The system of claim 3, wherein the processor is further configured to:
enter codes into a display as part of the transaction where the card of the health plan member is swiped;
the codes being transformed into identifiable units for health plans for payment, and
the codes being compared to units for payment sent by the health care provider in a health care claim.

14. The system of claim 3, wherein the processor is further configured to:
compare the information from the card swipe of the health plan member and codes entered at an authorized provider office at the provider office to codes submitted in a corresponding medical claim.

15. The system of claim 3, wherein the processor is further configured to:
deny payment if information from the provider card and health plan member card originating from locations are not authorized by a health plan.

16. The system of claim 3, wherein the processor is further configured to:
utilize insurance claim information collected by the insurance company to generate a score of risk that the provider is submitting fraudulent or abusive claims to an insurance company;
wherein, information on health care claims submitted to the insurance company is compared with information provided to the insurance company by the activity in their credit card terminals; and
wherein information on health care claims submitted to the insurance company is further compared with responses to requests to verify the location and terminal specifics of their credit card terminal, and the information held on the insurance company information systems databases regarding claims submitted, amounts paid, and static information available to the insurance company from governmental applications and filings made by the provider.

17. A method for validating and verifying health care transactions, comprising:
capturing the name of a provider of health care services including products;
verifying that the provider and a location of the provider is authorized to provide the health care services to an individual insured by a health plan; and
allowing access to information on the individual insured by the health plan if the provider is authorized by the health plan to provide the health care services.

18. A method for validating and verifying health care transactions, comprising:
capturing time and location and details of a visit by a person to an authorized health care provider location;
delivering information to a health care insurer or claim processor in real time; and
providing a process of matching health care encounter information captured at the location of the health care provider with claim information submitted to a health insurance company or claim processor as a separate process from the medical visit.

19. A computer readable medium comprising:
instruction code for capturing time and location and details of a visit by a person to an authorized health care provider location;
instruction code for delivering information to a health care insurer or claim processor in real time; and
instruction code for providing a process of matching health care encounter information captured at the location of the health care provider with claim information submitted to a health insurance company or claim processor as a separate process from the medical visit.

20. A computer readable medium comprising:
instruction code for capturing the name of a provider of health care services including products;
instruction code for verifying that the provider and a location of the provider is authorized to provide the health care services to an individual insured by a health plan; and
instruction code for allowing access to information on the individual insured by the health plan if the provider is authorized by the health plan to provide the health care services.
